(19) United States
(12) Patent Application Publication
(10) Pub. No.: US 2025/0094324 A1
(43) Pub. Date: Mar. 20, 2025

(54) INTELLIGENT GENERATION OF UNIT TESTS

(71) Applicant: SAP SE, Walldorf (DE)

(72) Inventors: Wulf Kruempelmann, Altlussheim (DE); Claudia Conrad, Oestringen (DE); Susanne Schott, Walldorf (DE)

(21) Appl. No.: 18/469,361

(22) Filed: Sep. 18, 2023

(51) Int. Cl. G06F 11/36

(52) U.S. Cl. CPC G06F 11/3684; G06F 11/3688; G06F 11/3692

(57) ABSTRACT

Arrangements for intelligent generation of unit tests are provided. A facade of a method of a class isolating code from a subsystem may be generated. The facade may include input variables and output variables. The facade of the method may be parsed to identify allowed input values for the input variables and expected output values for the output variables. User input specifying one or more parameters for the input variables may be received based on the identified allowed input values. Based on the received user input, a database table with every combination of the input variables with the output variables may be populated and stored in a data store. A unit test method may be executed on each row of the database table. Outputs of the unit test method may be compared to corresponding expected output values in the database table to determine whether there is a match.

### TECHNICAL FIELD

The subject matter described herein relates generally to cloud computing and more specifically to intelligent generation of unit tests.

### BACKGROUND

In cloud software development, unit tests may be built to ensure the stability of software after fixes. For example, unit tests may provide a check that an application meets its design specifications and behaves as intended. Typically, a developer must write complete unit tests for each method, programming each unit test one by one. For example, if a developer is working on a form, the developer would carry out a unit test on each item of the form in order to ensure that the configurations or customizations work as they should. It can be difficult, time-consuming, and inefficient to write unit tests manually since developers must take the time to write and debug the test code.

### SUMMARY

Methods, systems, and articles of manufacture, including computer program products, are provided for intelligent generation of unit tests. In one aspect, there is provided a system including at least one processor and at least one memory. The at least one memory can store instructions that cause operations when executed by the at least one processor. The operations may include: generating a facade of a method of a class, the facade may include input variables and output variables, and the facade may isolate code from a subsystem; parsing the facade of the method, the parsing may identify allowed input values for the input variables and expected output values for the output variables; receive user input specifying one or more parameters for the input variables based on the identified allowed input values for the input variables; based on the received user input, populating a database table with every combination of the input variables with the output variables; storing the database table in a data store; executing a unit test method on each row of the database table; comparing outputs of the unit test method to corresponding expected output values in the database table; and determining whether the outputs of the unit test method match the corresponding expected output values in the database table.

In some variations, one or more of the features disclosed herein including the following features can optionally be included in any feasible combination. In some variations, the operations may further include receiving additional user input modifying the one or more parameters for the input variables, and the modifying may include specifying one or more additional parameters associated with additional use cases; repopulating the database table with every combination of the input variables with the output variables based on the received additional user input; and storing the database table in the data store.

In some variations, determining whether the outputs of the unit test method match the corresponding expected output values in the database table may include determining a degree of similarity between each output of the unit test method and each corresponding expected output value.

In some variations, the operations may further include transmitting a notification to a computing device based on determining one or more outputs of the unit test method fail to match a corresponding expected output value.

In some variations, receiving the user input specifying the one or more parameters for the input variables may include receiving a plurality of fixed values.

In some variations, receiving the user input specifying the one or more parameters for the input variables may include receiving a list of character strings.

In some variations, receiving the user input specifying the one or more parameters for the input variables may include receiving one or more constraints specifying a range of values. In some variations, the range of values may include one or more of a lower limit and an upper limit.

In another aspect, there is provided a method for intelligent generation of unit tests. The method may include: generating a facade of a method of a class, the facade may include input variables and output variables, and the facade may isolate code from a subsystem; parsing the facade of the method, the parsing may identify allowed input values for the input variables and expected output values for the output variables; receive user input specifying one or more parameters for the input variables based on the identified allowed input values for the input variables; based on the received user input, populating a database table with every combination of the input variables with the output variables; storing the database table in a data store; executing a unit test method on each row of the database table; comparing outputs of the unit test method to corresponding expected output values in the database table; and determining whether the outputs of the unit test method match the corresponding expected output values in the database table.

In some variations, one or more of the features disclosed herein including the following features can optionally be included in any feasible combination. The method may further include receiving additional user input modifying the one or more parameters for the input variables, and the modifying may include specifying one or more additional parameters associated with additional use cases; repopulating the database table with every combination of the input variables with the output variables based on the received additional user input; and storing the database table in the data store.

In some variations, determining whether the outputs of the unit test method match the corresponding expected output values in the database table may include determining a degree of similarity between each output of the unit test method and each corresponding expected output value.

In some variations, the method may further include transmitting a notification to a computing device based on determining one or more outputs of the unit test method fail to match a corresponding expected output value.

In some variations, receiving the user input specifying the one or more parameters for the input variables may include receiving a plurality of fixed values.

In some variations, receiving the user input specifying the one or more parameters for the input variables may include receiving a list of character strings.

In some variations, receiving the user input specifying the one or more parameters for the input variables may include receiving one or more constraints specifying a range of values. In some variations, the range of values may include one or more of a lower limit and an upper limit.

In another aspect, there is provided a computer program product that includes a non-transitory computer readable medium. The non-transitory computer readable medium may store instructions that cause operations when executed by at least one data processor. The operations may include: generating a facade of a method of a class, the facade may include input variables and output variables, and the facade may isolate code from a subsystem; parsing the facade of the method, the parsing may identify allowed input values for the input variables and expected output values for the output variables; receive user input specifying one or more parameters for the input variables based on the identified allowed input values for the input variables; based on the received user input, populating a database table with every combination of the input variables with the output variables; storing the database table in a data store; executing a unit test method on each row of the database table; comparing outputs of the unit test method to corresponding expected output values in the database table; and determining whether the outputs of the unit test method match the corresponding expected output values in the database table.

In some variations, one or more of the features disclosed herein including the following features can optionally be included in any feasible combination. In some variations, the non-transitory computer readable medium may store instructions that that cause operations further including receiving additional user input modifying the one or more parameters for the input variables, and the modifying may include specifying one or more additional parameters associated with additional use cases; repopulating the database table with every combination of the input variables with the output variables based on the received additional user input; and storing the database table in the data store.

In some variations, determining whether the outputs of the unit test method match the corresponding expected output values in the database table may include determining a degree of similarity between each output of the unit test method and each corresponding expected output value.

In some variations, the non-transitory computer readable medium may store instructions that that cause operations further including transmitting a notification to a computing device based on determining one or more outputs of the unit test method fail to match a corresponding expected output value.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an illustrative computing environment for intelligent generation of unit tests in accordance with some example embodiments;

FIG. 2 depicts a flowchart illustrating a process for implementing intelligent generation of unit tests in accordance with some example embodiments;

FIG. 3 depicts an example of a database table operated upon by an enterprise software application in accordance with some example embodiments; and

FIG. 4 depicts a block diagram illustrating a computing system, in accordance with some example embodiments.

When practical, like labels are used to refer to same or similar items in the drawings.

### DETAILED DESCRIPTION

Aspects of the disclosure provide effective, efficient, scalable, and convenient technical solutions that address and overcome the technical problems associated with intelligently generating unit tests. Unit testing is an approach used during the development stage for testing the behavior of a unit of production code. Unit testing includes testing the smallest piece of code that can be logically isolated and tested in such an isolation (e.g., a method, function module, subroutine, etc.). Thus, unit testing may verify whether the independent behavior of every single unit of code is as expected, covering all test cases or test scenarios from a target script.

Aspects of the disclosure may build an intelligent unit test generation program that loops through a database table and checks every entry via a single unit test method, without requiring a user (e.g., developer) to create multiple or numerous unit tests that depend on the combinations of possible values. In some examples, a facade of a method class may be created. In addition, the facade may describe input and output parameters of the method. An intelligent unit test generation method may read and interpret the facade method and create a table in a database. Aspects of the disclosure may prefill a set of possible input values for parameters having fixed input values. Additionally or alternatively, user (e.g., a developer) may manually indicate possible values for other data. For example, users may create entries that are typical for the use cases. Thereafter, unit tests may select all entries from the table and start the method for each row. For example, the intelligent unit test generation program may select software source code and run functional tests, providing user-defined variables to the software, and check if the expected values meet expectations. If the results of the methods correspond to the expected results, then the unit test passes. If the results of the methods do not correspond to the expected results, then the errors or issues in the code may be identified and reported. These and various other arrangements will be discussed more fully below.

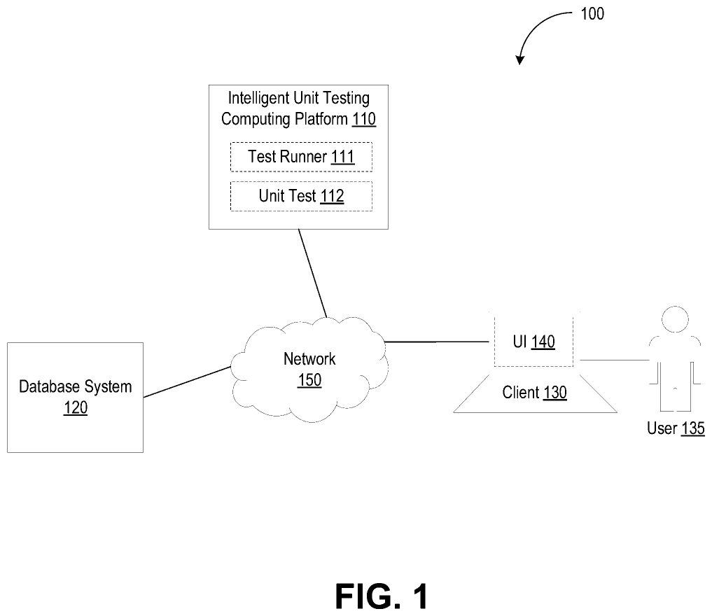

FIG. 1 depicts an illustrative computing environment 100 for intelligent generation of unit tests in accordance with some example embodiments. Referring to FIG. 1, computing environment 100 may include one or more computing devices and/or other computing systems. For example, computing environment may include an intelligent unit testing computing platform 110, a database system/data store 120, and a client device 130. Although one database system 120 and one client device 130 are shown, any number of data sources or devices may be used without departing from the disclosure.

The intelligent unit testing computing platform 110, the database system 120, and the client device 130 may be communicatively coupled via a network 150. The client device 130 may be a processor-based device including, for example, a smartphone, a tablet computer, a wearable apparatus, a virtual assistant, an Internet-of-Things (IoT) appliance, and/or the like. The database system 120 may include, for example, a relational database, a non-structured query language (NoSQL) database, an in-memory database, a graph database, a key-value store, a document store, and/or the like. The network 150 may be any wired network and/or a wireless network including, for example, a wide area network (WAN), a local area network (LAN), a virtual local area network (VLAN), a public land mobile network (PLMN), the Internet, and/or the like.

Referring again to FIG. 1, the intelligent unit testing computing platform 110 may include one or more computing devices configured to perform one or more of the functions described herein. In some example embodiments, the intelligent unit testing computing platform 110 may comprise a test runner 110 used to execute tests and export results. In some examples, the test runner 110 may orchestrate the execution of one or more tests (e.g., tests invoked by client device 130). In addition, test runner 110 may provide the outcome/results of executing the tests to a user (e.g., of user computing device/client device 130). For instance, test runner 111 may select source code (e.g., from database system 120), run functional tests (e.g., via unit test 112), and export results (e.g., to client device 130).

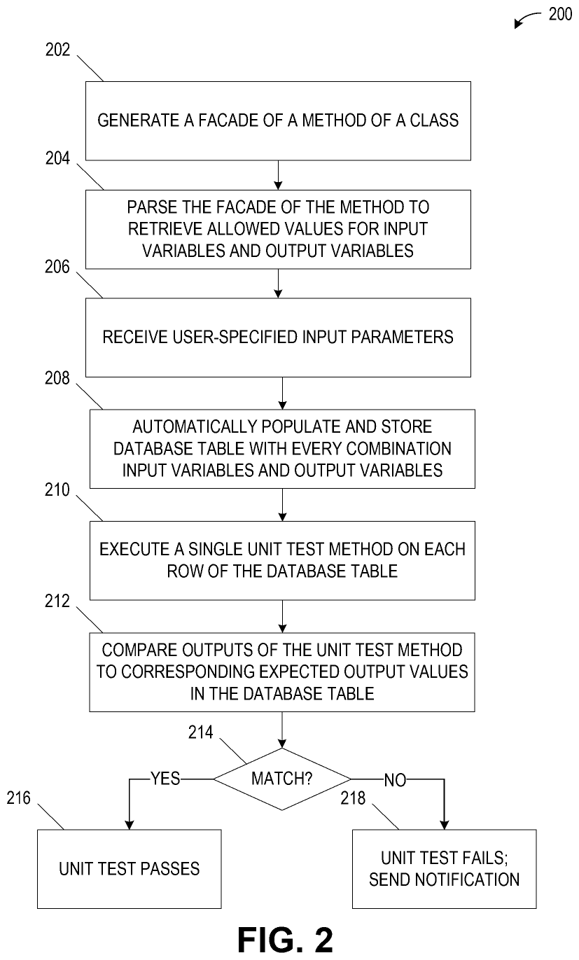

FIG. 2 depicts a flowchart illustrating a process 200 for implementing intelligent generation of unit tests in accordance with some example embodiments. Referring to FIGS. 1-3, the process 200 may be performed using an intelligent unit testing computing platform 110.

At 202, the computing platform 110 may generate a facade of a method of a class created by a developer (e.g., user 135 at client device 130). The facade method may include input variables and output variables. The facade method described herein provides a simplified interface to an existing complex system often consisting of several subsystems. The facade method facilitates easier access to methods of underlying systems by providing a single entry point, helping to hide or abstract the complexities of the subsystems. For example, facade methods may isolate a client from a subsystem (e.g., promoting loose coupling) so that the client can interact with the facade rather than the subsystem (e.g., when working with complex or hard to test code). Moreover, the facade method provides a design pattern to more easily test complex classes. At step 204, the computing platform 110 may parse the facade of the method. In some examples, parsing the facade method identifies allowed input values for the input variables and expected output values for the output variables.

At step 206, the computing platform 110 may receive user input (e.g., from user 135 at client device 130 via user interface 140) specifying one or more parameters for the input variables based on the identified allowed input values for the input variables. In some examples, the user input may specify a plurality of fixed values. Additionally or alternatively, the user input may specify a list of character strings. Additionally or alternatively, the user input may specify one or more constraints including a range of values, which may include one or more of a lower limit and an upper limit.

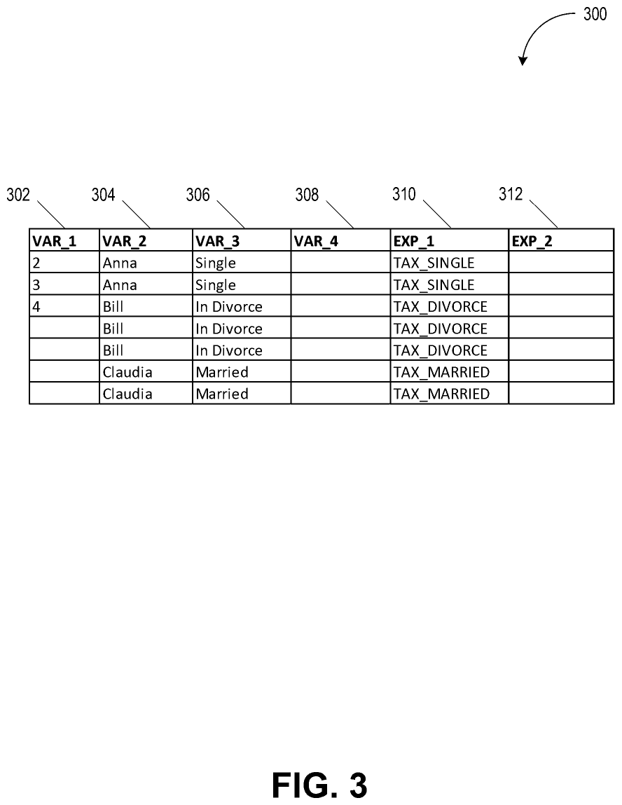

At step 208, based on the received user input, the computing platform 110 may automatically populate a database table with every combination of the input variables with the output variables. In addition, the computing platform 110 may store the database table in a data store (e.g., database system 120). In one non-limiting example, as shown in FIG. 3, the database table 300 may include different columns. For instance, the database table 300 may include the columns for input parameters and output parameters. For instance, database table 300 may include input parameters may include variables 302, 304, 306, and 308 (e.g., VAR_1, VAR_2, VAR_3, and VAR_4, respectively). At 302, a user might declare or otherwise indicate the possible values for VAR_1 to be “all integers.” At 304, the user might declare or otherwise indicate the possible values for VAR_2 to be “Anna,” “Bill,” and “Claudia.” At 306, the user might declare or otherwise indicate the possible values for VAR_3 to be “Married,” “Single,” and “In Divorce.” At 308, the user might declare or otherwise indicate the possible values for VAR_4 to be “all strings.” In addition, output parameters may include expected values 310 and 312 (e.g., EXP_1 and EXP_2, respectively). At 310, the user might declare or otherwise indicate the possible expected values for EXP_1 to be “TAX_SINGLE,” “TAX_DIVORCED,” and “TAX_MARRIED.” At 312, the user might declare or otherwise indicate the possible expected values for EXP_2 to be “all strings.” In some instances, a minimum value (e.g., a lower limit) and/or a maximum value (e.g., an upper limit) may be indicated. It will be appreciated that other and/or different parameters and/or data may also be provided.

Returning to FIG. 2, at step 210, the computing platform 110 may call and execute a unit test method on each row of the database table (e.g., database table 300). For instance, the computing platform 110 may select all the entries from the database table (e.g., database table 300) and start the unit test method for each row. For example, the computing platform 110 may automatically loop through all the entries in the database table and test all possible or potential combinations of input and output variables (e.g., to check if a software is sound).

At step 212, the computing platform 110 may compare outputs of the unit test method to corresponding expected output values in the database table (e.g., database table 300). At step 214, the computing platform 110 may determine whether the outputs of the unit test method match the corresponding expected output values in the database table (e.g., validates if a given input leads to an expected output). For example, the computing platform 110 may determine a degree of similarity between each output of the unit test method and each corresponding expected output value. At step 216, based on determining that the outputs of the unit test method match their corresponding expected output values, the unit test passes. At step 218, based on determining that one or more outputs of the unit test method fail to match a corresponding expected output value, the computing platform 110 may transmit a notification or alert to a computing device (e.g., indicating which input or output parameter was affected and/or which result was not as expected).

In some embodiments, the computing platform 110 may receive additional user input modifying the one or more parameters for the input variables (e.g., as new requirements come in, or requirements are removed, etc.). For example, the additional user input may specify one or more additional parameters associated with additional use cases. Additionally or alternatively, the modifying may include deleting one or more parameters stored in the database table (e.g., database table 300). Based on the received additional user input, the computing platform 110 may repopulate the database table with every combination of the input variables with the output variables and store the database table in the data store, repeating steps 308 through 318.

Advantageously, a user need not write a unit test method for each and every combination check. Rather, the user (e.g., developer) may enter the values and write or call one unit test method, and the computing system would automatically loop through the table and test all potential combinations. Development time may be shortened and the system would be less error prone (e.g., less likely to miss combinations).

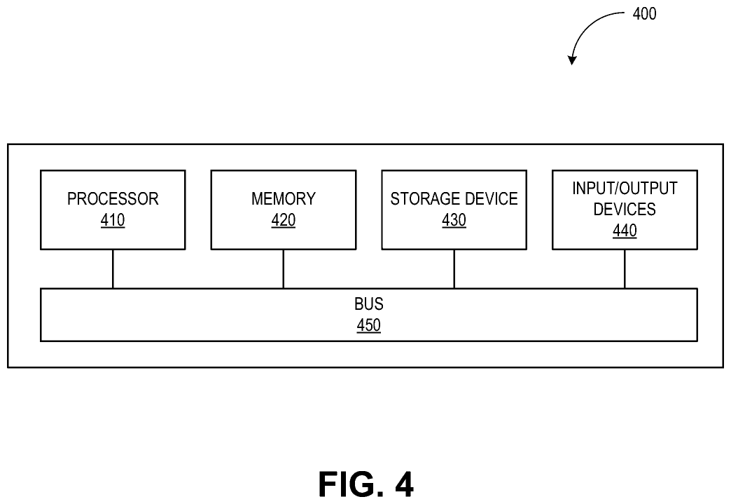

FIG. 4 depicts a block diagram illustrating a computing system 400 consistent with implementations of the current subject matter. Referring to FIGS. 1-4, the computing system 400 can be used to implement the intelligent unit testing computing platform 110 and/or any components therein.

As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The processor 410 is capable of processing instructions for execution within the computing system 400. Such executed instructions can implement one or more components of, for example, the intelligent unit testing computing platform 110. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a solid-state device, a floppy disk device, a hard disk device, an optical disk device, a tape device, and/or any other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one data processor; and
at least one memory storing instructions, which when executed by the at least one data processor, result in operations comprising:
   generating a facade of a method of a class, wherein the facade comprises input variables and output variables, and wherein the facade isolates code from a subsystem;
   parsing the facade of the method, wherein the parsing identifies allowed input values for the input variables and expected output values for the output variables;
   receive user input specifying one or more parameters for the input variables based on the identified allowed input values for the input variables;
   based on the received user input, populating a database table with every combination of the input variables with the output variables;
   storing the database table in a data store;
   executing a unit test method on each row of the database table;
   comparing outputs of the unit test method to corresponding expected output values in the database table; and
   determining whether the outputs of the unit test method match the corresponding expected output values in the database table.

Example 2: The system of Example 1, further comprising: receiving additional user input modifying the one or more parameters for the input variables, wherein the modifying comprises specifying one or more additional parameters associated with additional use cases; based on the received additional user input, repopulating the database table with every combination of the input variables with the output variables; and storing the database table in the data store.

Example 3: The system of any of Examples 1-2, wherein determining whether the outputs of the unit test method match the corresponding expected output values in the database table comprise determining a degree of similarity between each output of the unit test method and each corresponding expected output value.

Example 4: The system of any of Examples 1-3, further comprising: based on determining one or more outputs of the unit test method fail to match a corresponding expected output value, transmitting a notification to a computing device.

Example 5: The system of any of Examples 1-4, wherein receiving the user input specifying the one or more parameters for the input variables comprises receiving a plurality of fixed values.

Example 6: The system of any of Examples 1-5, wherein receiving the user input specifying the one or more parameters for the input variables comprises receiving a list of character strings.

Example 7: The system of any of Examples 1-6, wherein receiving the user input specifying the one or more parameters for the input variables comprises receiving one or more constraints specifying a range of values.

Example 8: The system of Example 7, wherein the range of values comprises one or more of a lower limit and an upper limit.

Example 9: A computer-implemented method, comprising:
generating a facade of a method of a class, wherein the facade comprises input variables and output variables, and wherein the facade isolates code from a subsystem;
parsing the facade of the method, wherein the parsing identifies allowed input values for the input variables and expected output values for the output variables;
receive user input specifying one or more parameters for the input variables based on the identified allowed input values for the input variables;
based on the received user input, populating a database table with every combination of the input variables with the output variables;
storing the database table in a data store;
executing a unit test method on each row of the database table;
comparing outputs of the unit test method to corresponding expected output values in the database table; and
determining whether the outputs of the unit test method match the corresponding expected output values in the database table.

Example 10: The method of Example 9, further comprising: receiving additional user input modifying the one or more parameters for the input variables, wherein the modifying comprises specifying one or more additional parameters associated with additional use cases; based on the received additional user input, repopulating the database table with every combination of the input variables with the output variables; and storing the database table in the data store.

Example 11: The method of any of Examples 9-10, wherein determining whether the outputs of the unit test method match the corresponding expected output values in the database table comprise determining a degree of similarity between each output of the unit test method and each corresponding expected output value.

Example 12: The method of any of Examples 9-11, further comprising: based on determining one or more outputs of the unit test method fail to match a corresponding expected output value, transmitting a notification to a computing device.

Example 13: The method of any of Examples 9-12, wherein receiving the user input specifying the one or more parameters for the input variables comprises receiving a plurality of fixed values.

Example 14: The method of any of Examples 9-13, wherein receiving the user input specifying the one or more parameters for the input variables comprises receiving a list of character strings.

Example 15: The method of any of Examples 9-14, wherein receiving the user input specifying the one or more parameters for the input variables comprises receiving one or more constraints specifying a range of values.

Example 16: The method of Example 15, wherein the range of values comprises one or more of a lower limit and an upper limit.

Example 17: A non-transitory computer readable medium storing instructions, which when executed by at least one data processor, result in operations comprising:
generating a facade of a method of a class, wherein the facade comprises input variables and output variables, and wherein the facade isolates code from a subsystem;
parsing the facade of the method, wherein the parsing identifies allowed input values for the input variables and expected output values for the output variables;
receive user input specifying one or more parameters for the input variables based on the identified allowed input values for the input variables;
based on the received user input, populating a database table with every combination of the input variables with the output variables;
storing the database table in a data store;
executing a unit test method on each row of the database table;
comparing outputs of the unit test method to corresponding expected output values in the database table; and
determining whether the outputs of the unit test method match the corresponding expected output values in the database table.

Example 18: The non-transitory computer readable medium of Example 17, further comprising: receiving additional user input modifying the one or more parameters for the input variables, wherein the modifying comprises specifying one or more additional parameters associated with additional use cases; based on the received additional user input, repopulating the database table with every combination of the input variables with the output variables; and storing the database table in the data store.

Example 19: The non-transitory computer readable medium of any of Examples 17-18, wherein determining whether the outputs of the unit test method match the corresponding expected output values in the database table comprise determining a degree of similarity between each output of the unit test method and each corresponding expected output value.

Example 20: The non-transitory computer readable medium of any of Examples 17-19, wherein the instructions, when executed by the at least one data processor, further result in operations comprising: based on determining one or more outputs of the unit test method fail to match a corresponding expected output value, transmitting a notification to a computing device.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one data processor; and
at least one memory storing instructions, which when executed by the at least one data processor, result in operations comprising:
generating a facade of a method of a class, wherein the facade comprises input variables and output variables, and wherein the facade isolates code from a subsystem;
parsing the facade of the method, wherein the parsing identifies allowed input values for the input variables and expected output values for the output variables;
receive user input specifying one or more parameters for the input variables based on the identified allowed input values for the input variables;
based on the received user input, populating a database table with every combination of the input variables with the output variables;
storing the database table in a data store;
executing a unit test method on each row of the database table;
comparing outputs of the unit test method to corresponding expected output values in the database table; and
determining whether the outputs of the unit test method match the corresponding expected output values in the database table.

2. The system of claim 1, further comprising:
receiving additional user input modifying the one or more parameters for the input variables, wherein the modifying comprises specifying one or more additional parameters associated with additional use cases;
based on the received additional user input, repopulating the database table with every combination of the input variables with the output variables; and
storing the database table in the data store.

3. The system of claim 1, wherein determining whether the outputs of the unit test method match the corresponding expected output values in the database table comprise determining a degree of similarity between each output of the unit test method and each corresponding expected output value.

4. The system of claim 1, further comprising:
based on determining one or more outputs of the unit test method fail to match a corresponding expected output value, transmitting a notification to a computing device.

5. The system of claim 1, wherein receiving the user input specifying the one or more parameters for the input variables comprises receiving a plurality of fixed values.

6. The system of claim 1, wherein receiving the user input specifying the one or more parameters for the input variables comprises receiving a list of character strings.

7. The system of claim 1, wherein receiving the user input specifying the one or more parameters for the input variables comprises receiving one or more constraints specifying a range of values.

8. The system of claim 7, wherein the range of values comprises one or more of a lower limit and an upper limit.

9. A computer-implemented method, comprising:
generating a facade of a method of a class, wherein the facade comprises input variables and output variables, and wherein the facade isolates code from a subsystem;
parsing the facade of the method, wherein the parsing identifies allowed input values for the input variables and expected output values for the output variables;
receive user input specifying one or more parameters for the input variables based on the identified allowed input values for the input variables;
based on the received user input, populating a database table with every combination of the input variables with the output variables;
storing the database table in a data store;
executing a unit test method on each row of the database table;
comparing outputs of the unit test method to corresponding expected output values in the database table; and
determining whether the outputs of the unit test method match the corresponding expected output values in the database table.

10. The method of claim 9, further comprising:
receiving additional user input modifying the one or more parameters for the input variables, wherein the modifying comprises specifying one or more additional parameters associated with additional use cases;
based on the received additional user input, repopulating the database table with every combination of the input variables with the output variables; and
storing the database table in the data store.

11. The method of claim 9, wherein determining whether the outputs of the unit test method match the corresponding expected output values in the database table comprise determining a degree of similarity between each output of the unit test method and each corresponding expected output value.

12. The method of claim 9, further comprising:
based on determining one or more outputs of the unit test method fail to match a corresponding expected output value, transmitting a notification to a computing device.

13. The method of claim 9, wherein receiving the user input specifying the one or more parameters for the input variables comprises receiving a plurality of fixed values.

14. The method of claim 9, wherein receiving the user input specifying the one or more parameters for the input variables comprises receiving a list of character strings.

15. The method of claim 9, wherein receiving the user input specifying the one or more parameters for the input variables comprises receiving one or more constraints specifying a range of values.

16. The method of claim 15, wherein the range of values comprises one or more of a lower limit and an upper limit.

17. A non-transitory computer readable medium storing instructions, which when executed by at least one data processor, result in operations comprising:
generating a facade of a method of a class, wherein the facade comprises input variables and output variables, and wherein the facade isolates code from a subsystem;
parsing the facade of the method, wherein the parsing identifies allowed input values for the input variables and expected output values for the output variables;
receive user input specifying one or more parameters for the input variables based on the identified allowed input values for the input variables;
based on the received user input, populating a database table with every combination of the input variables with the output variables;
storing the database table in a data store;
executing a unit test method on each row of the database table;
comparing outputs of the unit test method to corresponding expected output values in the database table; and
determining whether the outputs of the unit test method match the corresponding expected output values in the database table.

18. The non-transitory computer readable medium of claim 17, further comprising:
receiving additional user input modifying the one or more parameters for the input variables, wherein the modifying comprises specifying one or more additional parameters associated with additional use cases;
based on the received additional user input, repopulating the database table with every combination of the input variables with the output variables; and
storing the database table in the data store.

19. The non-transitory computer readable medium of claim 17, wherein determining whether the outputs of the unit test method match the corresponding expected output values in the database table comprise determining a degree of similarity between each output of the unit test method and each corresponding expected output value.

20. The non-transitory computer readable medium of claim 17, wherein the instructions, when executed by the at least one data processor, further result in operations comprising:
based on determining one or more outputs of the unit test method fail to match a corresponding expected output value, transmitting a notification to a computing device.
